(19) United States
(12) Patent Application Publication
(10) Pub. No.: US 2009/0179366 A1
(43) Pub. Date: Jul. 16, 2009

(54) APPARATUS FOR SUPPORTING A SUBSTRATE DURING SEMICONDUCTOR PROCESSING OPERATIONS

(75) Inventors: Harald Herchen, Los Altos, CA (US); Kim Vellore, San Jose, CA (US); Erica Renee Porras, Boone, NC (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Shimogyo-ku (JP)

(21) Appl. No.: 12/015,060

(22) Filed: Jan. 16, 2008

(51) Int. Cl. B25B 11/00

(52) U.S. Cl. 269/21

(57) ABSTRACT

An apparatus for supporting a substrate during semiconductor processing includes a substrate support structure having a first surface, a second surface opposing the first surface, and a groove recessed into the first surface and defining a peripheral portion of the substrate support structure. The substrate support structure is substantially free of guide pins. The apparatus also includes an annular sealing member coupled to the groove and a plurality of proximity pins projecting to a first height above the first surface. The apparatus further includes a plurality of purge ports passing from the second surface to the first surface, a plurality of vacuum ports passing from the second surface to the first surface, and a heating mechanism coupled to the substrate support structure.

### BACKGROUND OF THE INVENTION

The present invention relates generally to the field of semiconductor processing equipment. More particularly, the present invention relates to a method and apparatus for supporting a substrate inside a semiconductor processing chamber. The method and apparatus can be applied to electrostatic chucks, vacuum chucks, and other applications as well.

Substrate support chucks are widely used to support substrates within semiconductor processing systems. Two examples of particular types of chucks used in semiconductor processing systems include electrostatic chucks (e-chucks) and vacuum chucks. These chucks are used to retain semiconductor substrates, or other work pieces, in a substantially stationary position during processing.

In some semiconductor processing steps, for example in a photoresist bake operation, a substrate rests flush against the surface of the chuck body during processing. During substrate processing, the chuck material can abrade the material present on the underside of the substrate, resulting in the introduction of particulate contaminants to the process environment. Consequently, during substrate processing operations, the particles can adhere themselves to the underside of the substrate and be carried to other process chambers or cause defects in the circuitry fabricated upon the substrate.

Over the years, there has been a strong push within the semiconductor industry to shrink the size of semiconductor devices. The reduced feature sizes have caused the industry's tolerance to process variability to shrink, which in turn, has resulted in semiconductor manufacturing specifications having more stringent requirements for process uniformity and repeatability. For example, during bake processes, it is desirable to provide uniform thermal treatment across the substrate. Because processed substrates are generally characterized by substrate bowing, achieving uniform thermal treatment is hindered by the different air gaps between portions of the substrate and the chuck.

Thus, there is a need in the art for improved method and systems for supporting substrates and compensating for substrate shape, including substrate warping, during semiconductor processing operations. Moreover, there is a need in the art for methods and systems to reduce the amount of contaminant particles that adhere to the underside of a substrate during thermal processing operations.

### SUMMARY OF THE INVENTION

According to embodiments of the present invention, techniques related to the field of substrate processing are provided. More particularly, the present invention relates to a method and apparatus for supporting a substrate and compensating for substrate shape during semiconductor processing operations. The method and apparatus can be applied to electrostatic chucks, vacuum chucks, and other applications as well.

In a specific embodiment of the present invention, a substrate support structure is provided. The substrate support structure includes a first surface and a second surface opposite the first surface. The substrate support structure includes a plurality of proximity pins projecting to a first height above the first surface. The substrate support structure also includes a sealing member along an outer region of the structure. In addition, the substrate support structure further includes a plurality of purge ports passing from the second surface to the first surface and a plurality of vacuum ports passing from the second surface to the first surface.

According to another embodiment of the present invention, a method of operating a substrate support structure is provided. The method includes placing a substrate to be processed on the annular sealing member and applying vacuum to pull the substrate towards the top surface of the support structure, thereby compressing the sealing member. The method also includes resting the substrate on the proximity pins and purging the structure to release the substrate after the processing is complete.

Many benefits are achieved by way of the present invention over conventional techniques. For example, embodiments of the present invention support the substrate and compensate for the warpage in the substrate, thereby reducing the amount of vacuum needed to prevent the substrate from sliding during the bake process. Moreover, some embodiments utilize a composition of a sealing ring material in which the sealing ring is compliant when a substrate is placed on the sealing ring. These embodiment reduce the possibility of scratching of the substrate backside, which can result in particulate contaminants. These and other benefits will be described in more detail throughout the present specification and more particularly below in conjunction with the following drawings.

### BRIEF DESCRIPTION OF THE DRAWINGS

FIG. 1 is a simplified schematic diagram of a track lithography tool in which embodiments of the present invention may be implemented;

FIG. 2 is a simplified schematic plan view of a substrate support structure according to one embodiment of the present invention;

FIG. 3A is a perspective view of substrate support structure according to one embodiment of the present invention;

FIG. 3B is a perspective view of a cross-section of the substrate support structure illustrated in FIG. 3A according to one embodiment of the present invention;

FIG. 3C is a cross-sectional view of a bake station according to one embodiment of the present invention;

FIG. 4A is a simplified view of a substrate during a first phase of a substrate loading operation according to one embodiment of the present invention;

FIG. 4B is a simplified view of a substrate during a second phase of a substrate loading operation according to one embodiment of the present invention;

FIG. 5 is a simplified cross-sectional view of the substrate support structure according to one embodiment of the present invention; and

FIG. 6 is a simplified flowchart illustrating a method of processing a substrate according to an embodiment of the present invention.

### DETAILED DESCRIPTION OF SPECIFIC EMBODIMENTS

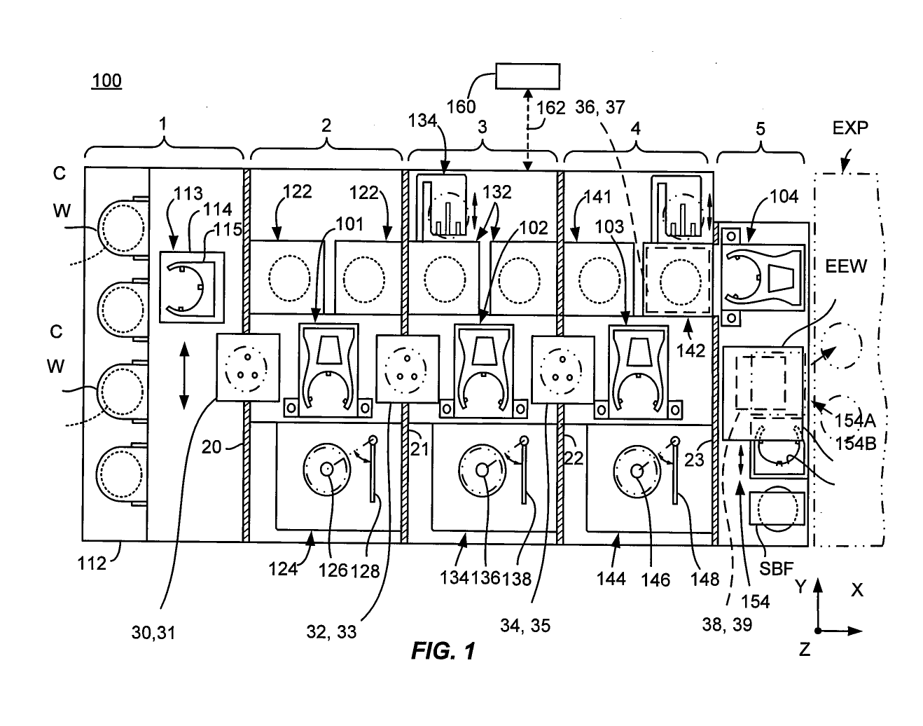

FIG. 1 is a plan view of a track lithography tool according to an embodiment of the present invention. In the embodiment illustrated in FIG. 1, the track lithography tool is coupled to an immersion scanner. An XYZ rectangular coordinate system in which an XY plane is defined as the horizontal plane and a Z-axis is defined to extend in the vertical direction is additionally shown in FIG. 1 for purposes of clarifying the directional relationship therebetween.

In a particular embodiment, the track lithography tool is used to form, through use of a coating process, an anti-reflection (AR) and a photoresist film on substrates, for example, semiconductor substrates. The track lithography tool is also used to perform a development process on the substrates after they have been subjected to a pattern exposure process. The substrates processed by the track lithography tool are not limited to semiconductor substrates, but may include glass substrates for a liquid crystal display device, and the like.

The track lithography tool 100 illustrated in FIG. 1 includes an factory interface block 1, a BARC (Bottom Anti-Reflection Coating) block 2, a resist coating block 3, a development processing block 4, and a scanner interface block 5. In the track lithography tool, the five processing blocks 1 to 5 are arranged in a side-by-side relation. An exposure unit (or stepper) EXP, which is an external apparatus separate from the track lithography tool is provided and coupled to the scanner interface block 5. Additionally, the track lithography tool and the exposure unit EXP are connected via LAN lines 162 to a host computer 160.

The factory interface block 1 is a processing block for transferring unprocessed substrates received from outside of the track lithography tool to the BARC block 2 and the resist coating block 3. The factory interface block 1 is also useful for transporting processed substrates received from the development processing block 4 to the outside of the track lithography tool. The factory interface block 1 includes a table 112 configured to receive a number of (in the illustrated embodiment, four) cassettes (or carriers) C, and a substrate transfer mechanism 113 for retrieving an unprocessed substrate W from each of the cassettes C and for storing a processed substrate W in each of the cassettes C. The substrate transfer mechanism 113 includes a movable base 114, which is movable in the Y direction (horizontally) along the table 112, and a robot arm 115 mounted on the movable base 114.

The robot arm 115 is configured to support a substrate W in a horizontal position during substrate transfer operations. Additionally, the robot arm 115 is capable of moving in the Z direction (vertically) in relation to the movable base 114, pivoting within a horizontal plane, and translating back and forth in the direction of the pivot radius. Thus, using the substrate transfer mechanism 113, the holding arm 115 is able to gain access to each of the cassettes C, retrieve an unprocessed substrate W out of each cassette C, and store a processed substrate W in each cassette C. The cassettes C may be one or several types including: an SMIF (standard mechanical interface) pod; an OC (open cassette), which exposes stored substrates W to the atmosphere; or a FOUP (front opening unified pod), which stores substrates W in an enclosed or sealed space.

The BARC block 2 is positioned adjacent to the factory interface block 1. Partition 20 may be used to provide an atmospheric seal between the factory interface block 1 and the BARC block 2. The partition 20 is provided with a pair of vertically arranged substrate rest parts 30 and 31 each used as a transfer position when transferring a substrate W between the factory interface block 1 and the BARC block 2.

The upper substrate rest part 30 is used for the transport of a substrate W from the factory interface block 1 to the BARC block 2. The substrate rest part 30 includes three support pins. The substrate transfer mechanism 113 of the factory interface block 1 places an unprocessed substrate W, which was taken out of one of the cassettes C, onto the three support pins of the substrate rest part 30. A transport robot 101 in the BARC block 2 (described more fully below) is configured to receive the substrate W placed on the substrate rest part 30. The lower substrate rest part 31, on the other hand, is used for the transport of a substrate W from the BARC block 2 to the factory interface block 1. The substrate rest part 31 also includes three support pins. The transport robot 101 in the BARC block 2 places a processed substrate W onto the three support pins of the substrate rest part 31. The substrate transfer mechanism 113 is configured to receive the substrate W placed on the substrate rest part 31 and then store the substrate W in one of the cassettes C. Pairs of substrate rest parts 32-39 (which are described more fully below) are similar in construction and operate in an analogous manner to the pair of substrate rest parts 30 and 31.

The substrate rest parts 30 and 31 extend through the partition 20. Each of the substrate rest parts 30 and 31 include an optical sensor (not shown) for detecting the presence or absence of a substrate W thereon. Based on a detection signal from each of the sensors, control of the substrate transfer mechanism 113 and the transport robot 101 of the BARC block 2 is exercised to transfer and receive a substrate W to and from the substrate rest parts 30 and 31.

Referring to FIG. 1 again, BARC block 2 is also included in the track lithography tool 100. The BARC block 2 is a processing block for forming an AR film (also referred to as a BARC) on a substrate using a coating process. The BARC is positioned in the film stack under the photoresist film, which is subsequently deposited. The BARC reduces standing waves or halation occurring during exposure. The BARC block 2 includes a bottom coating processor 124 configured to coat the surface of a substrate W with the AR film, a pair of thermal processing towers 122 for performing one or more thermal processes that accompany the formation of the AR film, and the transport robot 101, which is used in transferring and receiving a substrate W to and from the bottom coating processor 124 and the pair of thermal processing towers 122.

In the BARC block 2, the bottom coating processor 124 and the pair of thermal processing towers 122 are arranged on opposite sides of the transport robot 101. Specifically, the bottom coating processor 124 is on the front side of the track lithography tool and the pair of thermal processing towers 122 are on the rear side thereof. Additionally, a thermal barrier (not shown) is provided on the front side of the pair of thermal processing towers 122. Thus, the thermal crosstalk from the pair of thermal processing towers 122 to the bottom coating processor 124 is reduced by the spacing between the bottom coating processor 124 and the pair of thermal processing towers 122 and through the use of the thermal barrier.

Generally, the bottom coating processor 124 includes three vertically stacked coating processing units that are similar in construction. The three coating processing units are collectively referred to as the bottom coating processor 124, unless otherwise identified. Each of the coating processing units includes a spin chuck 126 on which the substrate W is rotated in a substantially horizontal plane while the substrate W is held in a substantially horizontal position through suction. Each coating processing unit also includes a coating nozzle 128 used to apply a coating solution for the AR film onto the substrate W held on the spin chuck 126, a spin motor (not shown) configured to rotatably drive the spin chuck 126, a cup (not shown) surrounding the substrate W held on the spin chuck 22, and the like.

The thermal processing towers 122 include a number of bake plates used to heat a substrate W to a predetermined temperature and a number of cool plates used to cool a heated substrate down to a predetermined temperature and thereafter maintain the substrate at the predetermined temperature. The bake plates and cool plates are vertically stacked, with the cool plates generally mounted underneath the bake plates. The thermal processing towers may also include a number of vertically stacked adhesion promotion units (e.g., HMDS treatment units). Vertical stacking of processing units reduces the tool footprint and reduces the amount of ancillary equipment (e.g., temperature and humidity control apparatus, electrical service, and the like).

Referring once again to FIG. 1, the resist coating block 3 is a processing block for forming a resist film on the substrate W after formation of the AR film in the BARC block 2. In a particular embodiment, a chemically amplified resist is used as the photoresist. The resist coating block 3 includes a resist coating processor 134 used to form the resist film on top of the AR film, a pair of thermal processing towers 132 for performing one or more thermal processes accompanying the resist coating process, and the transport robot 102, which is used to transfer and receive a substrate W to and from the resist coating processor 134 and the pair of thermal processing towers 132.

Similar to the configuration of the processors in BARC block 2, the resist coating processor 134 and the pair of thermal processing towers 132 are arranged on opposite sides of the transport robot 102. A thermal barrier (not shown) is provided to reduce thermal crosstalk between processors. Generally, the resist coating processor 134 includes three vertically stacked coating processing units that are similar in construction. Each of the coating processing units includes a spin chuck 136, a coating nozzle 138 for applying a resist coating to the substrate W, a spin motor (not shown), a cup (not shown), and the like.

The thermal processing towers 132 include a number of vertically stacked bake chambers and cool plates. In a particular embodiment, the thermal processing tower closest to the factory interface block 1 includes bake chambers and the thermal processing tower farthest from the factory interface block 1 includes cool plates. In the embodiment illustrated in FIG. 1, the bake chambers include a vertically stacked bake plate and temporary substrate holder as well as a local transport mechanism 134 configured to move vertically and horizontally to transport a substrate W between the bake plate and the temporary substrate holder and may include an actively chilled transport arm. The transport robot 102 is identical in construction to the transport robot 101 in some embodiments. The transport robot 102 is able to independently access substrate rest parts 32 and 33, the thermal processing towers 132, the coating processing units provided in the resist coating processor 134, and the substrate rest parts 34 and 35.

The development processing block 4 is positioned between the resist coating block 3 and the scanner interface block 5. A partition 22 for sealing the development processing block from the atmosphere of the resist coating block 3 is provided. The upper substrate rest part 34 is used to transport a substrate W from the resist coating block 3 to the development processing block 4. The lower substrate rest part 35, on the other hand, is used to transport a substrate W from the development processing block 4 to the resist coating block 3. As described above, substrate rest parts 32-39 may include an optical sensor for detecting the presence or absence of a substrate W thereon. Based on a detection signal from each of the sensors, control of the various substrate transfer mechanisms and transport robots of the various processing blocks is exercised during substrate transfer processes.

The development processing block 4 includes a development processor 144 for applying a developing solution to a substrate W after exposure in the scanner EXP, a pair of thermal processing towers 141 and 142, and transport robot 103. The development processor 144 includes five vertically stacked development processing units that are similar in construction to each other. Each of the development processing units includes a spin chuck 146, a nozzle 148 for applying developer to a substrate W, a spin motor (not shown), a cup (not shown), and the like.

Thermal processing tower 142 includes bake chambers and cool plates as described above. Additionally, thermal processing tower 142 is accessible to both transport robot 103 as well as transport robot 104. Thermal processing unit 141 is accessible to transport robot 103. Additionally, thermal processing tower 142 includes substrate rest parts 36 and 37, which are used when transferring substrates to and from the development processing block 4 and the scanner interface block 5.

The interface block 5 is used to transfer a coated substrate W to the scanner EXP and to transfer an exposed substrate to the development processing block 5. The interface block 5 in this illustrated embodiment includes a transport mechanism 154 for transferring and receiving a substrate W to and from the exposure unit EXP, a pair of edge exposure units EEW for exposing the periphery of a coated substrate, and transport robot 104. Substrate rest parts 39 and 39 are provided along with the pair of edge exposure units EEW for transferring substrates to and from the scanner and the development processing unit 4.

The transport mechanism 154 includes a movable base 154A and a holding arm 154B mounted on the movable base 154A. The holding arm 154B is capable of moving vertically, pivoting, and moving back and forth in the direction of the pivot radius relative to the movable base 154A. The send buffer SBF is provided to temporarily store a substrate W prior to the exposure process if the exposure unit EXP is unable to accept the substrate W, and includes a cabinet capable of storing a plurality of substrates W in tiers.

Controller 160 is used to control all of the components and processes performed in the cluster tool. The controller 160 is generally adapted to communicate with the scanner 5, monitor and control aspects of the processes performed in the cluster tool, and is adapted to control all aspects of the complete substrate processing sequence. The controller 160, which is typically a microprocessor-based controller, is configured to receive inputs from a user and/or various sensors in one of the processing chambers and appropriately control the processing chamber components in accordance with the various inputs and software instructions retained in the controller's memory. The controller 160 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 160 determines which tasks are performable in the processing chambers. Preferably, the program is software readable by the controller 160 and includes instructions to monitor and control the process based on defined rules and input data.

Additional description of a substrate processing apparatus in accordance with embodiments of the present invention is provided in U.S. Patent Application Publication No. 2006/0245855, entitled “Substrate Processing Apparatus,” and U.S. Pat. No. 7,282,675 B2, entitled “Integrated Thermal Unit Having A Shuttle With A Temperature Controlled Surface,” the disclosures of which are hereby incorporated by reference in their entirety. Although embodiments of the present invention are described herein in the context of the track lithography tool illustrated in FIG. 1, other architectures for track lithography tools are included within the scope of embodiments of the present invention. For example, track lithography tools utilizing Cartesian architectures are suitable for use with embodiments as described throughout the present specification. In a particular embodiment, implementation is performed for an RF³i, available from Sokudo Co., Ltd. of Kyoto, Japan.

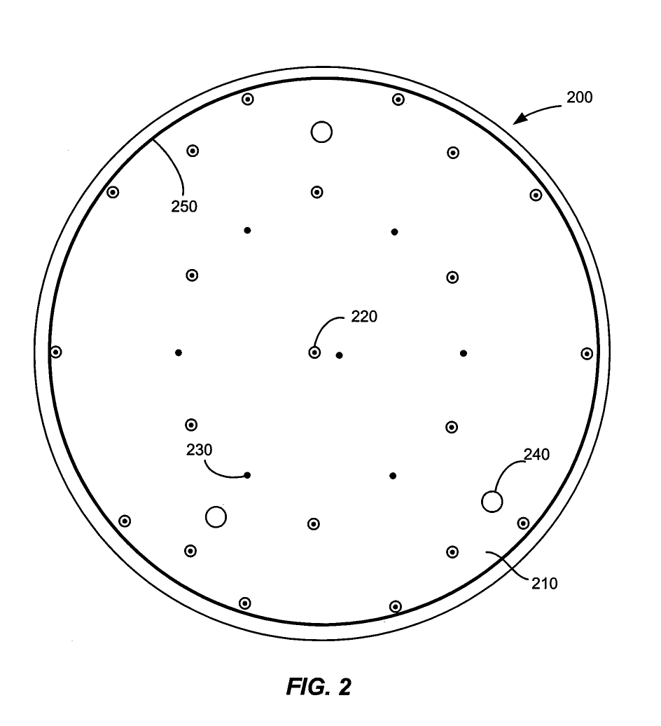

FIG. 2 is a simplified schematic plan view of a substrate support structure 200 according to one embodiment of the present invention. The substrate support structure 200 has a top surface 210. For purposes of clarity, the top surface 210 of the substrate support structure is illustrated in FIG. 2 with no substrate positioned on top of proximity pins 220. Thus, the embodiment illustrated in FIG. 2 provides one possible configuration of proximity pins 220, vacuum ports 230, and purge ports 240. In general, a number of proximity pins 220 are spaced across the surface of the substrate support structure 200 so that the contact area can be minimized and the gap between the substrate and the substrate support structure surface 210 can be maintained at a substantially uniform distance.

In addition, a number of vacuum ports 230 are spaced across the surface of the substrate support structure 200 so that the substrate can be uniformly biased towards the substrate support structure 200. In some embodiments, the use of vacuum ports 230 in conjunction with the proximity pins 220 provides for a substantially uniform gap between the substrate and the substrate support structure surface 210. In one embodiment, as shown in FIG. 2 an annular sealing member 250 is coupled to a peripheral region of the substrate support structure surface 210. The annular sealing member rises to a first height above the substrate support structure surface 210. In one embodiment, this height is approximately 500 μm. Additional details related to the annular sealing member 250 are provided throughout the present specification and more particularly below.

Various methods have been employed to increase the thermal coupling of the substrate to the substrate support structure and consequently to the heat exchanging device. Increased thermal coupling allows for reduction in the processing time, increased system throughput, and increased control over critical dimensions (CD). In a specific embodiment of the present invention, the thermal coupling is increased by decreasing the distance between the substrate and the substrate support structure. As is evident to one of skill in the art, decreasing the spacing between the substrate and the substrate support structure will lead to an increase in convective heat transfer across the gap.

Moreover, increasing the contact area between the substrate backside surface and the surface of the substrate support structure 200 will increase the thermal coupling and reduce the time it takes a substrate to reach the desired process temperature. However, increasing the contact area is often undesirable since it will generally increase the number of particles generated on the backside of the substrate, which can adversely impact the processing results and cause defects in the circuitry fabricated upon the substrate.

One method of reducing the number of particles generated on the backside of the substrate is to minimize the contact area of the substrate to the surfaces of the substrate support structure. Accordingly, an array of proximity pins or proximity pins that space the substrate off the surface of the substrate support structure have been utilized. While the use of proximity pins reduces the number of particles generated, they may tend to reduce the thermal coupling between the substrate and the plate assembly. Therefore, it is often desirable to minimize the height of the proximity pins above the surface of the plate assembly to improve the thermal coupling, while also maintaining the substrate substantially free from contact with the surface of the plate assembly. Some applications have used sapphire spheres that are pressed or placed into machined holes in the plate assembly surface to act as proximity pins.

Referring once again to FIG. 2, one embodiment of the present invention provides an array of accurately controlled small contact area proximity pins 220 that are formed on the surface of the substrate support structure 200. In the embodiment illustrated in FIG. 2, the substrate is biased towards the substrate support structure 200 by vacuum ports 230 to increase the thermal coupling between the substrate and the substrate support structure. One of ordinary skill in the art would recognize many variations, modifications, and alternatives. The array of accurately controlled small height proximity pins 220 can be formed by a variety of methods commonly known in the art.

In embodiments of the present invention, the proximity pins are distributed across the face of substrate support structure 200. For example, in one particular embodiment, 17 proximity pins are utilized with the following locations: one pin at the center, four pins arranged at corners of a square concentric with the center pin, with a side equal to 50 mm, twelve pins arranged near the periphery of the plate assembly, separated from each other by arcs of 30°. Preferably, the proximity pins are fabricated from a material with a low coefficient of friction. In one embodiment, the proximity pins are fabricated from a ceramic material. In alternative embodiments, proximity pins 220 are fabricated from silicon, silicon oxides, metals, polymers, diamond, diamond-like carbon, boron nitride, single crystalline α-alumina, polycrystalline β-alumina, combinations thereof or other suitable materials. One of ordinary skill in the art would recognize many variations, modifications, and alternatives. Accordingly, contact between the proximity pins and the substrate will produce a reduced number of particles.

According to calculations performed by the inventors, it is desirable to select the distribution pitch of proximity pins across the face plate surface to achieve goals related to maximum substrate bowing. Utilizing a 74 mm pitch between adjacent proximity pins, we have determined that it is possible to support a substrate with a maximum bowing at the substrate edge of about 5 μm. In designs with a 50 mm pitch between adjacent proximity pins, the maximum substrate bowing can be reduced to about 2.8 μm. Of course, the particular maximum bowing desired by the system operator will depend on the particular applications.

In some embodiments of the present invention, a two-step chucking process is utilized to flatten the substrate in a step-wise fashion. Generally, substrates or substrates possess a degree of bowing or warpage before they are placed on the substrate support. Thus, embodiments of the present invention use methods and systems to compensate for the substrate bowing, providing an increase in the uniformity of the gap between the substrate and the chuck surface. For example, in an embodiment using the annular sealing member 250, a first step is performed where the substrate is placed on the annular sealing member. The height of the annular sealing member is selected to ensure that the substrate initially rests substantially on the sealing member. As described more fully throughout the present specification, the sealing member is made of a compliant material that expands in a horizontal direction under the pressure of the substrate, thereby sealing the substrate at the edges early on in the process. In a second step, a vacuum pressure is applied to the back of the substrate to bias the substrate towards the surface of the substrate assembly. The annular sealing member is squeezed due to this vacuum pressure and helps to compensate for the bow in the substrate. The substrate is thus substantially flat as it comes to rest on the proximity pins 220.

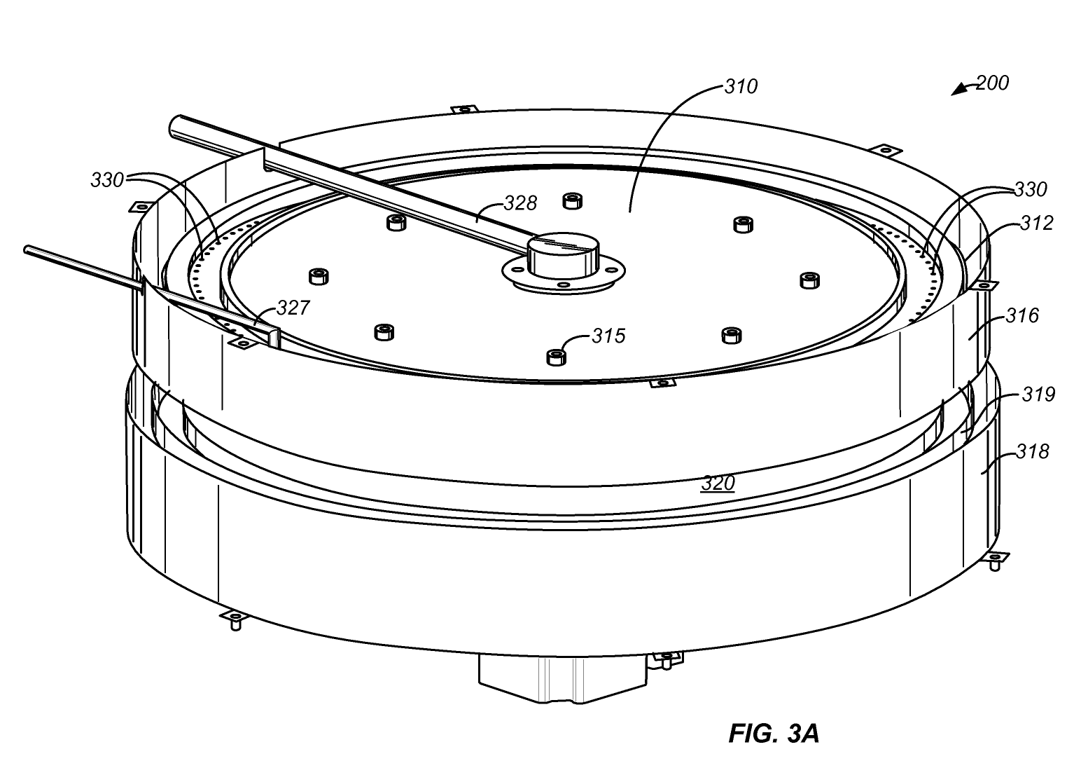

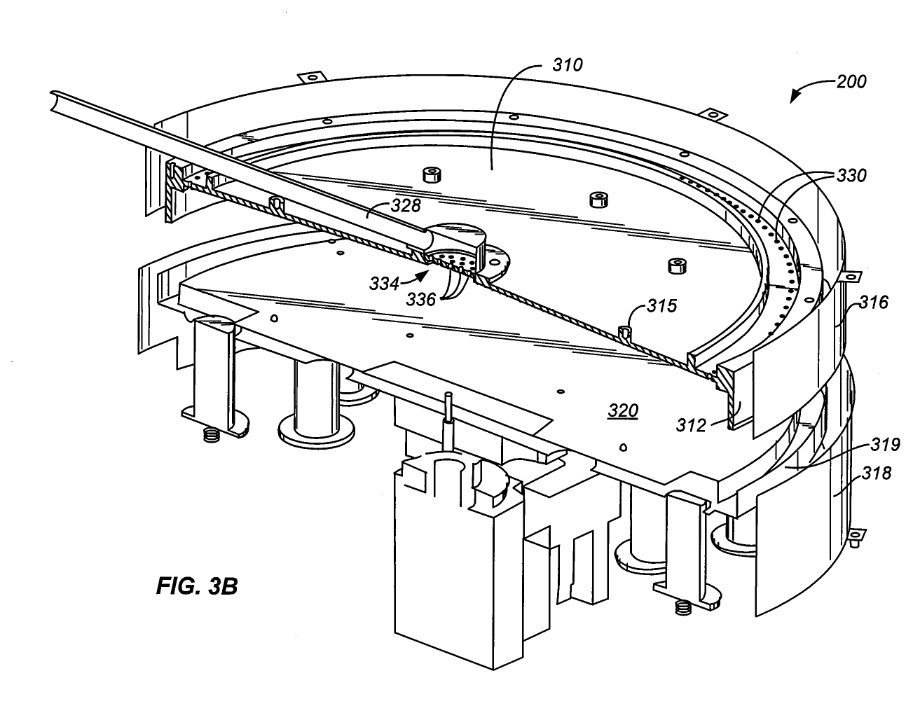

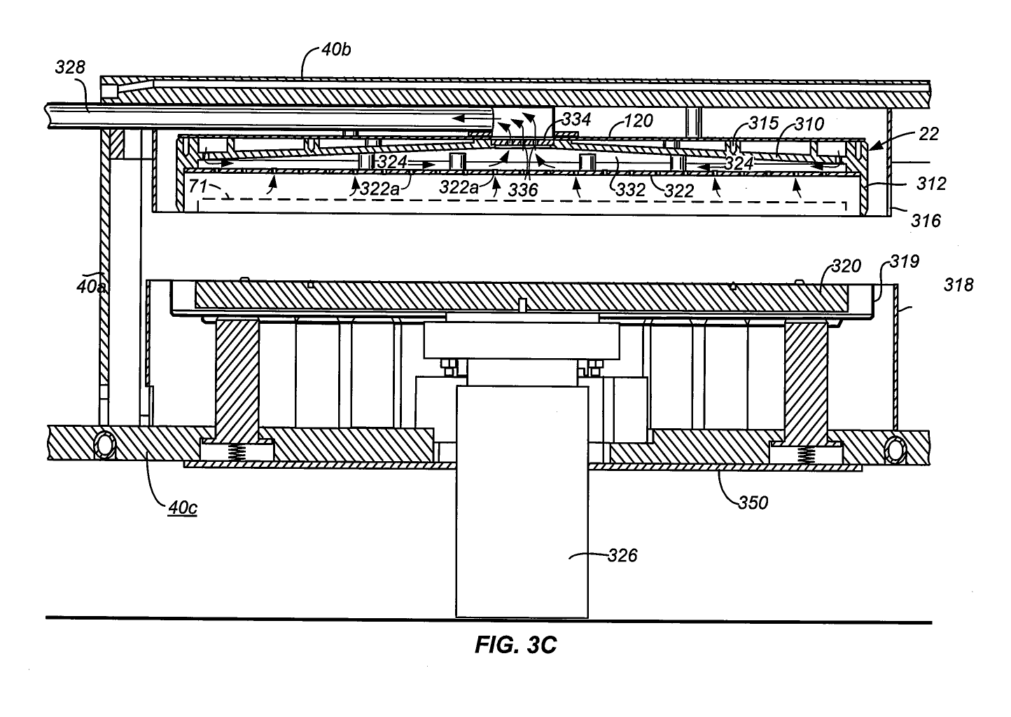

Reference is now made to FIGS. 3A, 3B, and 3C where FIG. 3A is a perspective view of substrate support structure 200 shown in FIG. 2B according to one embodiment of the invention; FIG. 3B is a perspective view of a cross-section of the substrate support structure 200 shown in FIG. 2; and FIG. 3C is a cross-sectional view of the bake station. According to one embodiment of the invention, substrate support structure 300 has three separate isothermal heating elements: bake plate 320, top heat plate 310, and side heat plate 312, each of which is manufactured from a material exhibiting high heat conductivity, such as aluminum or other appropriate material. Each plate 320, 310, 312 has a heating element, for example, resistive heating elements, embedded within the plate. Bake station 312 also includes side top and bottom heat shields 316 and 318, respectively, as well as a bottom cup 319 that surrounds bake plate 320 and a lid 120 (not shown). Each of heat shields 316, 318, cup 319 and lid 120 are made from aluminum. Lid 120 is attached to top heat plate 310 by eight screws that are threaded through threaded holes 315.

Bake plate 320 is operatively coupled to a motorized lift 326 so that the bake plate can be raised into a clamshell enclosure 322 and lowered into a substrate receiving position. Typically, substrates are heated on bake plate 320 when it is raised to a baking position 71. When in the baking position, cup 319 encircles a bottom portion of side heat plate 312 forming a clamshell arrangement that helps confine heat generated by bake plate 320 within an inner cavity formed by the bake plate and enclosure 322. In one embodiment, the upper surface of bake plate 320 includes 17 proximity pins similar to those described above. Also, in one embodiment bake plate 320 includes a plurality of vacuum ports 230, described above, and be operatively coupled to a vacuum system to secure a substrate to the bake plate during the baking process.

During the baking process, a faceplate 322 is positioned just above and opposite substrate support surface 210 of bake plate 320. Faceplate 322 can be made from aluminum as well as other suitable materials and includes a plurality of holes or channels 322a that allow gases and contaminants baked off the surface of a substrate being baked on bake plate 320 to drift through faceplate 322 and into a radially inward gas flow 324 that is created between faceplate 322 and top heat plate 3 10.

Gas from radially inward gas flow 324 is initially introduced into substrate support structure 200 at an annular gas manifold that encircles the outer portion of top heat plate 310 and is provided in fluid communication with gas inlet line 327. The gas manifold includes numerous small gas inlets 330 that allow gas to flow from the manifold into the cavity 332 between the lower surface of top heat plate 310 and the upper surface of faceplate 322. The gas flows radially inward towards the center of the station through a diffusion plate 334 that includes a plurality of gas outlet holes 336. After flowing through diffusion plate 334, gas exits bake station 200 through gas outlet line 328. Merely by way of example, the plate 320 may be an aluminum plate coated with Teflon® manufactured by DuPont Incorporated of Wilmington, Del. or Tufram® manufactured by General Magnaplate Corporation of Linden, N.J. In alternative embodiments, plate 320 is fabricated from stainless steel, silicon carbide, copper, pyrolitic graphite, aluminum, aluminum nitride, aluminum oxide, boron nitride, certain ceramics or combinations/laminates of these materials with certain features placed on it.

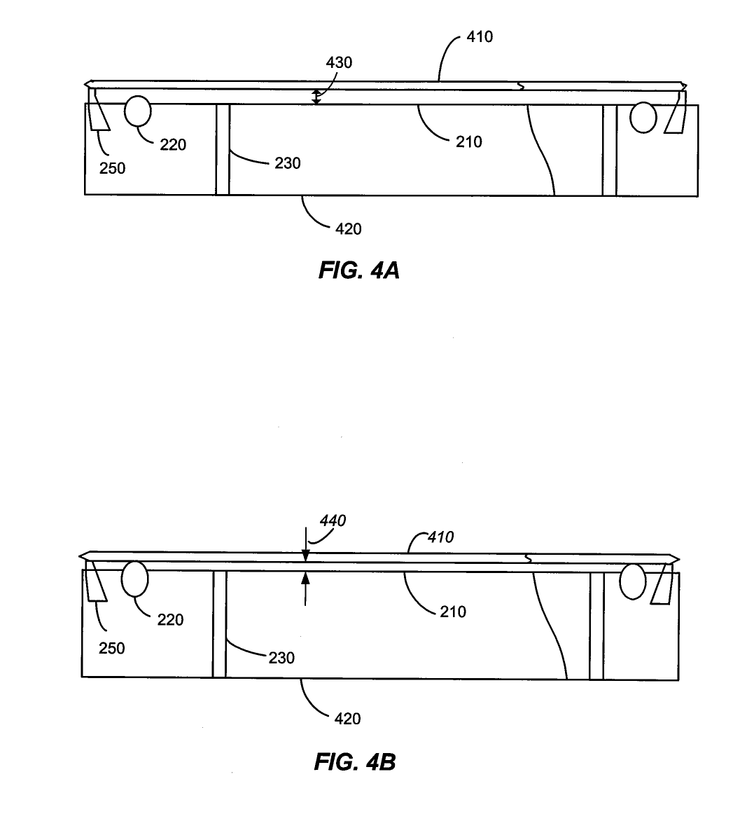

FIG. 4A is a simplified view of a substrate during a first phase of a substrate loading operation according to one embodiment of the present invention. Merely by way of example FIG. 4A shows the substrate 410 as it is loaded onto the substrate support structure 200. Initially, the substrate 410 is placed onto an annular sealing member 250. The annular sealing member is made of a resilient but soft material to enable it to be compressed under the weight of the substrate. Prior to compression of the sealing member by the weight of the substrate, the sealing member 250 rises to a predetermined height 430 above the surface 210 of the substrate support structure. In various embodiments, the predetermined height 430 ranges from about 100 μm to about 600 μm. In a particular embodiment, the predetermined height 430 is approximately 500 μm. One skilled in the art will appreciate that this height can vary by the nature of the application and composition of the sealing member.

The vertical thickness of the sealing member is adjusted in some embodiments to ensure that the thermal conductivity through the sealing member is equal to the thermal conductivity of the air gap that surrounds it. Balancing of the thermal conductivities helps to provide uniform heat coupling across the substrate by eliminating the heat conductivity difference between areas of substrate that touch the annular sealing member and those portions having an air gap to the support structure.

One of the other characteristics of the sealing member is that it is capable of horizontal movement under the pressure of the substrate. This characteristic of the sealing member helps to seal the substrate at the edges early in the processing step even if the substrate is bowed or warped. One advantage of achieving such a seal between the substrate and sealing member is described in detail in reference to FIG. 4B below. As is common in semiconductor processing operations, often the incoming substrate will have some material left over on its edges as a result of prior processing steps. Since the sealing member is compliant, it moves horizontally under the weight of the substrate as the substrate is placed over the sealing member. This concurrent movement of the sealing member and the substrate helps to eliminate the dislodgement of any material present on the edge of the substrate. This in turn helps to reduce the particulate generation that can be detrimental to the devices formed on the substrate in later processing steps.

FIG. 4B is a simplified view of a substrate during a second phase of a substrate loading operation according to one embodiment of the present invention. As illustrated in FIG. 4B, the substrate 410 has come to rest on the proximity pins 220. In one embodiment, after the substrate is placed on the sealing member, a vacuum pressure is applied through the vacuum ports 230 to bias the substrate towards the surface 210 of the substrate support structure and rest it on the proximity pins 220. At the rest position, the air gap 440 between the substrate is less than the air gap 430 at the load position illustrated in FIG. 4A. The air gap 440 is approximately equal to the height of the proximity pins 220. According to various embodiments, the height 440 ranges from about 20 μm to about 100 μm. In one embodiment, the height 440 is about 60 μm.

Another advantage realized by the use of the sealing member to seal the substrate in the beginning of the process is that the amount of vacuum pressure required to hold the substrate onto the proximity pins is considerably less than what would be required if the substrate is not sealed before the vacuum pressure is applied. As discussed above, the incoming substrate usually has some kind of bow or warpage associated with it. Sealing of the substrate as illustrated in FIG. 4A enables a reduction in the vacuum pressure applied to the substrate to transition the substrate into the position illustrated in FIG. 4B.

In one embodiment of the present invention, the substrate support structure is used during a substrate bake process performed in a track lithography tool. During the bake process, it is desirable to provide uniform thermal treatment across the substrate. Because processed substrates are generally characterized by substrate bowing as discussed above, achieving uniform thermal treatment is hindered by the different air gaps between the substrate and the bake plate as a function of position on the substrate. Hence, it is desirable to position the substrate as flat as possible on the substrate support structure during the thermal treatment process. As mentioned above, usually a vacuum pressure is used to hold the substrate during processing.

In conventional applications that do not use a sealing member to seal the substrate edges, a large vacuum pressure is needed to hold the substrate and position it flat on the proximity pins to compensate for the substrate bow. The typical vacuum pressure used in conventional designs is in the range of 3000 Pascals. When such a large vacuum pressure is used, it increases the possibility of substrate breakage and particulate generation. One advantage of using a sealing member to seal the edges of the substrate is that significantly less vacuum pressure is needed to compensate for the bow in the substrate, thereby decreasing the likelihood of particle generation and substrate breakage. Generally the vacuum pressure used is in the range of 250 Pascals to 400 Pascals. In one embodiment of the present invention, a vacuum pressure of about 300 Pascals is enough to hold and position the substrate substantially flat on the proximity pins. In addition, because of the application of a low vacuum pressure, the quantity of proximity pins needed to ensure substrate flatness is greatly reduced, thereby realizing substantial cost savings during the fabrication of the substrate support.

In conventional sealing techniques that use vacuum, guide pins that are installed just outside the periphery of the substrate rest location are utilized. Guide pins are used to help the substrate not stray out of the designated area due to skating. Skating is a phenomenon that occurs when a substrate is placed on a heated surface at atmospheric pressure. Since there is a thin layer of gas underneath the substrate, the substrate “glides” on that layer. As a result of skating, a substrate moves away from the location where it is initially placed. If the substrate moves away far enough, it results in process non-uniformity that is detrimental to the devices on the substrate. To reduce the problems due to skating, a number of guide pins are usually installed around the periphery of the optimal location of the substrate at a predetermined distance. These guide pins contain the substrate within the “pocket” that they create. Major disadvantages of having guide pins include particle generation, expensive fabrication, the need to replace them frequently due to wear and tear, and difficulties associated with removal and installation. In embodiments of the present invention, because the sealing member seals the substrate before the vacuum is applied, the possibility of substrate skating is significantly reduced and/or eliminated. Hence, some embodiments of the present invention do not use guide pins, thereby eliminating a potential source for particles and further adding to the cost savings.

Another advantage of eliminating the use of guide pins is that the substrate support structure surface area can be reduced. The diameter of the substrate support structure can be made approximately equal to that of the substrate. This results in a one to one correspondence between the bake plate and the substrate in some embodiments. In one embodiment, where the substrate support structure is configured to accept 300 mm substrates, the substrate support structure diameter can range between 302 mm and 310 mm. One of the advantages realized by this configuration is that heat transfer direction across the entire surface of the bake plate is substantially vertical and very little heat is lost due to horizontal transmission as there is substantially no extra thermal mass that is not covered by the substrate. This helps to keep the entire substrate at a uniform temperature, which is highly desirable as explained earlier.

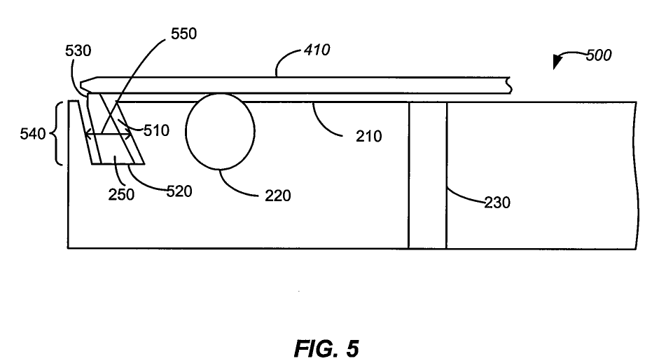

FIG. 5 is a simplified cross-sectional view of the substrate support structure according to one embodiment of the present invention. Among other features, FIG. 5 shows a number of details related to the sealing member 250. A groove 510 is etched into or otherwise formed in the top surface 210 of the substrate support structure 500. The depth 540 and width 550 of the groove is dependent on the type of sealing member used, for example, the thickness and the height of sealing member. The height of the groove can range between 0.3 mm and 4 mm, while the width of the groove can range between 0.4 mm and 1.2 mm. In one embodiment, this groove is about 2 mm deep and 0.8 mm wide. One of ordinary skill in the art would recognize many variations, modifications, and alternatives.

As illustrated in FIG. 5, the sealing member 250 is only coupled to the groove along a bottom portion 520. Thus, the sides of the sealing member are free from fixed contact with the sides of the groove in some embodiments. Further, the sealing member 250 is tilted towards the outside edge of the support structure and has a beveled top portion 530. This construction allows the sealing member to initially move in a horizontal direction under the weight of the substrate 410. As the substrate is heated during the bake process, it expands horizontally. Accordingly, the sealing member 250 moves horizontally along with the periphery of the expanding substrate, thus eliminating motion between the substrate and the sealing member. This prevents scratching of the bottom surface of substrate 410, thereby reducing the possibility of particulate generation. In moving horizontally, and during the compression action, the sealing member typically will not contact the side walls of the grove 510. One of ordinary skill in the art would recognize many variations, modifications, and alternatives.

The sealing member is typically made of material with a durometer value of approximately less than 50. In one embodiment, the sealing member has a durometer of less than 30. The sealing member is usually made from a fluoropolymer material. One example of such material is Perlast®, available from Perlast Ltd. of Blackburn, England. Other suitable materials that provide the characteristics described herein are included within the scope of embodiments of the present invention.

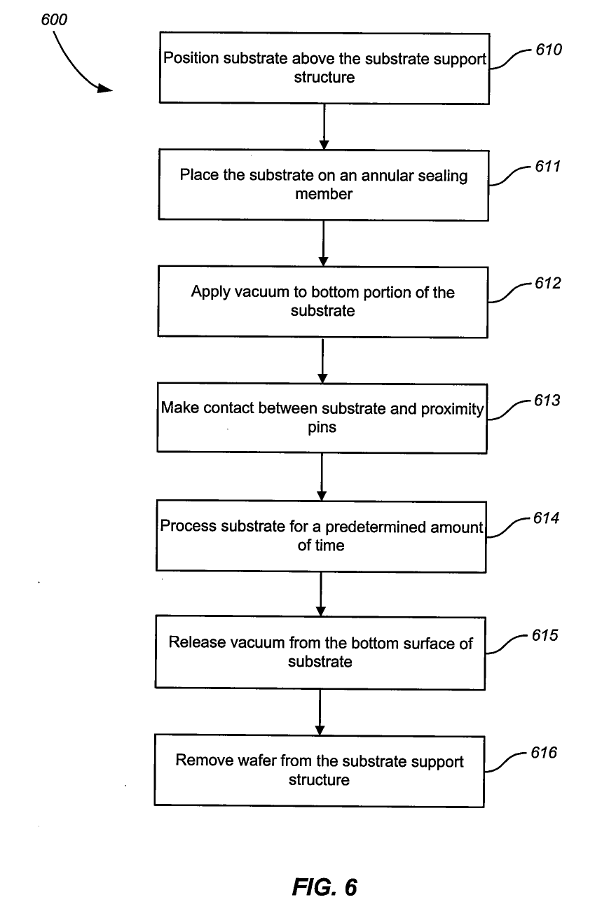

FIG. 6 is a simplified flowchart illustrating a method of processing a substrate according to an embodiment of the present invention. The method 600 includes positioning the substrate above a substrate support structure (610). The substrate support structure has a top surface and a peripheral region. Exemplary substrate support structures are illustrated and described more fully throughout the present specification, for example, in FIGS. 2-5. As illustrated in FIG. 5, the substrate support structure includes an annular sealing member 250 that is coupled to a circular groove 510 extending along a peripheral region of the top surface of the substrate support structure 500. The annular sealing member is mounted to the substrate support structure only along a bottom portion 520.

The method also includes placing the substrate onto the annular sealing member (611). The annular sealing member is compressed under the weight of the substrate. A vacuum pressure is applied to the bottom of the substrate via the vacuum ports to flatten the substrate and pull it towards the proximity pins (612). The substrate comes to rest after it contacts a plurality of proximity pins that project above the surface of the substrate support structure (613). During the process of making contact between the substrate and the plurality of proximity pins, it is not necessary that contact be made between the bottom of the substrate and all of the proximity pins simultaneously. For example, certain portions of the substrate may make contact with one or more proximity pins first because of substrate bow present prior to flattening of the substrate after application of the vacuum pressure. Thus, according to embodiments, the contact between the substrate and the proximity pins can occur sequentially, simultaneously, or a combination thereof.

Next, the substrate is processed for a predetermined time (614). In an exemplary embodiment, the substrate undergoes thermal processing in which the substrate is heated for specific duration of time to cure photoresist or other materials present on the substrate. During processing, the substrate expands horizontally. Since the sealing member is composed of resilient but soft material and by virtue of its construction, the sealing member also undergoes a horizontal movement along with the substrate. This prevents scratching of the bottom side of the substrate. After the processing is complete, the vacuum is released from underneath the substrate (615). Thereafter the substrate is picked up from the support structure (616). After the substrate is picked up, the sealing member returns to its original shape and height, ready to accept another substrate.

It should be appreciated that the specific steps illustrated in FIG. 6 provide a particular method of processing a substrate according to an embodiment of the present invention. Other sequences of steps may also be performed according to alternative embodiments. For example, alternative embodiments of the present invention may perform the steps outlined above in a different order. Moreover, the individual steps illustrated in FIG. 6 may include multiple sub-steps that may be performed in various sequences as appropriate to the individual step. Furthermore, additional steps may be added or removed depending on the particular applications. One of ordinary skill in the art would recognize many variations, modifications, and alternatives.

While the present invention has been described with respect to particular embodiments and specific examples thereof, it should be understood that other embodiments may fall within the spirit and scope of the invention. The scope of the invention should, therefore, be determined with reference to the appended claims along with their full scope of equivalents.

What is claimed is:

1. An apparatus for supporting a substrate during semiconductor processing, the apparatus comprising:
a substrate support structure comprising a first surface, a second surface opposing the first surface, and a groove recessed into the first surface and defining a peripheral portion of the substrate support structure,
an annular sealing member coupled to the groove;
a plurality of proximity pins projecting to a first height above the first surface;
a plurality of purge ports passing from the second surface to the first surface;
a plurality of vacuum ports passing from the second surface to the first surface; and
a heating mechanism coupled to the substrate support structure.

2. The apparatus of claim 1 wherein the annular sealing member projects to a second height above the first surface of the substrate support structure, the second height being greater than the first height.

3. The apparatus of claim 2 wherein the second height is less than 600 μm.

4. The apparatus of claim 1 wherein the annular sealing member comprises a material with a durometer value of less than 30.

5. The apparatus of claim 4 wherein the annular sealing member comprises a fluoropolymer material.

6. The apparatus of claim 1 wherein the groove includes a bottom portion and opposing side portions and the annular sealing member is coupled to the substrate support structure along the bottom portion of the groove and substantially free from contact with the opposing side portions of the groove.

7. The apparatus of claim 1 wherein the annular sealing member comprises:
a base coupled to a bottom portion of the groove;
side portions extending from the base along a direction having a component perpendicular to the first surface; and
a beveled top portion coupled to the side portions.

8. The apparatus of claim 7 wherein the direction is tilted from normal towards an outer edge of the substrate support structure.

9. The apparatus of claim 1 wherein a diameter of the substrate support structure is approximately equal to a diameter of the substrate.

10. The apparatus of claim 9 wherein the diameter of the substrate support structure is less than 310 mm.

11. The apparatus of claim 1 wherein the plurality of proximity pins comprise a material selected from the group consisting of silicon, silicon oxides, metals, ceramics, polymers, diamond, diamond-like carbon, boron nitride, single crystalline α-alumina, and polycrystalline β-alumina.

12. The apparatus of claim 1 wherein the substrate support comprises a material selected from the group consisting of stainless steel, silicon carbide, copper, pyrolitic graphite, aluminum, aluminum nitride, aluminum oxide, boron nitride, anodized aluminum, and sealed anodized aluminum.

13. The apparatus of claim 1 wherein the first surface is substantially free of guide pins.

14. A method for processing a substrate on a substrate support structure, the method comprising:
positioning the substrate above the substrate support structure, wherein the substrate support structure has a top surface and a peripheral region;
placing the substrate onto an annular sealing member coupled to the peripheral region of the substrate support structure;
applying a vacuum pressure to the substrate, thereby compressing the annular sealing member;
making contact between the substrate and a plurality of proximity pins projecting to a first height above the top surface of the substrate support structure;
processing the substrate for a predetermined duration of time;
releasing the vacuum pressure from the substrate; and
removing the substrate from the substrate support structure.

15. The method of claim 14 wherein compressing the annular sealing member comprises reducing a height of the annular sealing member above the top surface of the substrate support structure from about 500 μm to the first height of the proximity pins.

16. The method of claim 14 wherein the first height of the proximity pins is about 60 μm.

17. The method of claim 14 wherein applying a vacuum pressure to the substrate comprises applying a vacuum pressure less than 400 Pascals.

18. The method of claim 14 wherein placing the substrate onto an annular sealing member further comprises:
raising a plurality of lift pins to a third height above the top surface of the substrate support structure;
placing the substrate onto the lift pins; and
raising the substrate support structure to a fourth height to support the substrate.

19. The method of claim 18 wherein the fourth height is greater than the third height.

20. A track lithography tool for processing a substrate comprising:
a plurality of pod assemblies adapted to accept one or more cassettes of substrates;
a plurality of processing modules adapted to perform various processing steps associated with a track lithography tool, the plurality of processing modules including at least one module for coating a substrate with photoresist, at least one module for developing the photoresist and one or more thermal processing units inside the track lithography tool, each of the thermal processing units comprising: (i) a substrate support structure substantially free of guide pins comprising a first surface and a second surface opposite the first surface; (ii) a annular sealing member coupled along a peripheral portion of the first surface; (iii) a plurality of proximity pins projecting to a first height above the first surface; (iv) a plurality of purge ports passing from the second surface to the first surface; (v) a plurality of vacuum ports passing from the second surface to the first surface; and (vi) a heating mechanism coupled to the substrate support structure; and
one or more robots adapted to transfer substrates from the one or more pod assemblies to selected processing modules within the track lithography tool or transfer substrates between selected processing modules in the plurality of processing modules.
